(19) United States
(12) Patent Application Publication
(10) Pub. No.: US 2017/0032746 A1
(43) Pub. Date: Feb. 2, 2017

(54) DRIVING CIRCUIT COMMUNICATION METHOD, COMMUNICATION DEVICE AND SYSTEM OF TFT-LCD

(71) Applicant: Shenzhen China Star Optpelectronics Technology Co. Ltd., Shenzhen, Guangdong (CN)

(72) Inventors: Yu-Yeh Chen, Shenzhen, Guangdong (CN); Liwei Zhu, Shenzhen, Guangdong (CN); Jianjun Xie, Shenzhen, Guangdong (CN); Yu Wu, Shenzhen, Guangdong (CN); Lei Sun, Shenzhen, Guangdong (CN)

(73) Assignee: Shenzhen China Star Optpelectronics Technology Co. Ltd., Shenzhen, Guangdong (CN)

(21) Appl. No.: 14/906,544

(22) PCT Filed: Aug. 28, 2015
(86) PCT No.: PCT/CN2015/088361

§ 371 Date: Jan. 20, 2016

(30) Foreign Application Priority Data
Jul. 31, 2015 (CN) 201510463938.1

(51) Int. Cl. G09G 3/36; G09G 3/20

(52) U.S. Cl. CPC G09G 3/36; G09G 3/2096; G09G 2310/02; G09G 2310/08; G09G 2360/12

(57) ABSTRACT

The present disclosure relates to a liquid crystal display field and discloses a driving circuit communication method, communication device and system of TFT-LCD. The driving circuit communication method includes: a timing controller reads device data of a target device from an external mounted storage device; the timing controller looks up for a device address corresponding to the device data of the target device according to a preset mapping relationship between the device data and the device address; and the timing controller writes the device working code of the target device into a data register of the target device according to the device address which is looked up and corresponding to the device data of the target device. Accordingly, the utilization rate of the external mounted storage device is increased so as to decrease a packaging area for the device and decrease the cost of the device at the same time.

### CROSS REFERENCE

This application claims the priority of Chinese Patent Application No. 201510463938.1, entitled “A driving circuit communication method, communication device and system of TFT-LCD”, filed on Jul. 31, 2015, the disclosure of which is incorporated herein by reference in its entirety.

### FIELD OF THE INVENTION

The present disclosure relates to a liquid crystal display field, and more specifically to a driving circuit communication method, communication device and system of TFT-LCD.

### BACKGROUND OF THE INVENTION

Currently, a Thin Film Transistor Liquid Crystal Display (TFT-LCD) is one of an active matrix liquid crystal display (AM-LCD). A timing controller of a driving circuit of a TFT-LCD reserves a configuration parameter through an external mounted storage device. A programmable gamma correction buffer circuit chip (P-Gamma), a power management chip (PWM IC) and other related devices reserve configuration parameters by fixed storage devices inside the programmable gamma correction buffer circuit chip (P-Gamma), the power management chip (PWM IC) and the related devices. Besides, the configuration parameters stored in the fixed storage device inside the devices require fixtures to perform debugging and writing.

In the above solution, codes of the timing controller stored in the external mounted storage device only occupied a little part of storage space of the external mounted storage device. Besides, a package size of a device that integrated with a fixed storage device is larger.

### SUMMARY OF THE INVENTION

In response to above deficiencies, the embodiment of the present embodiment provides a driving circuit communication method, communication device and system of TFT-LCD in order to increase an utilization rate of the external mounted storage device so as to decrease a packaging area for the device and decrease the cost of the device at the same time.

The first aspect of the present disclosure discloses a driving circuit communication method of a TFT-LCD, comprising:

a timing controller reads device data of a target device from an external mounted storage device, wherein, the external mounted storage device previously stores N device data respectively corresponding to N devices, and the device data includes a device configuration code and a device working code, wherein, the device working code includes a device configuration parameter and a device calibration parameter, and N is a positive integer, the target device is one of the N devices;

the timing controller looks up for a device address corresponding to the device data of the target device according to a preset mapping relationship between the device data and the device address; and

the timing controller writes the device working code of the target device into a data register of the target device according to the device address which is looked up and corresponding to the device data of the target device.

The second aspect of the present disclosure discloses a driving circuit communication device of a TFT-LCD, comprising:

a reading unit for reading device data of a target device from an external mounted storage device, wherein, the external mounted storage device previously stores N device data respectively corresponding to N devices, the device data comprises a device configuration code and a device working code, the device working code comprises a device configuration parameter and a device calibration parameter, and N is a positive integer, and the target device is one of the N devices;

a look-up unit for looking up for a device address corresponding to the device data of the target device according to a preset mapping relationship between the device data and the device address; and

a writing unit for writing the device working code of the target device read by the reading unit into a data register of the target device according to the device address which is looked up by the look-up unit and corresponding to the device data of the target device.

The third aspect of the present disclosure discloses a driving circuit system of a TFT-LCD comprising an external mounted storage device, a target device and a driving circuit communication device of a TFT-LCD, wherein:

the external mounted storage device is used for previously storing N device data of N target devices;

the target device is used for carrying device data, the device data includes a device configuration code and a device working code, and the device working code includes a device configuration parameter and a device calibration parameter; and

the driving circuit communication device of a TFT-LCD is used for reading device data of a target device from an external mounted storage device, looking up for a device address corresponding to the device data of the target device according to a preset mapping relationship between the device data and the device address, and writing the device working code of the target device which us read into a data register of the target device according to the device address which is looked up and corresponding to the device data of the target device.

In the present embodiment, the timing controller reads the device data of the target device from the external mounted storage device; looking up for the device address corresponding to the device data of the target device according to a preset mapping relationship between the device data and the device address; writing the device working code of the target device which is read into the data register of the target device according to the device address corresponding to the device data of the target device. In the present embodiment, in the external mounted storage device, a remaining space except a space for storing a code of a timing controller is used for storing the device data of the target device so that the target device does not require providing with a fixed storage device for storing the device data. Accordingly, the utilization rate of the external mounted storage device is increased so as to decrease a packaging area for the device and decrease the cost of the device at the same time.

### BRIEF DESCRIPTION OF THE DRAWINGS

In order to more clearly illustrate the technical solution in the present invention or in the prior art, the following will illustrate the figures used for describing the embodiments or the prior art. It is obvious that the following figures are only some embodiments of the present invention. For the person of ordinary skill in the art without creative effort, it can also obtain other figures according to these figures.

FIG. 1 is a flowchart of a driving circuit communication method of a TFT-LCD according to an embodiment of the present disclosure;

FIG. 2 is a flowchart of a driving circuit communication method of a TFT-LCD according to another embodiment of the present disclosure;

FIG. 3 is a flowchart of a driving circuit communication method of a TFT-LCD according to another embodiment of the present disclosure;

FIG. 4 is a schematic structure diagram of a driving circuit communication device of a TFT-LCD according to an embodiment of the present disclosure;

FIG. 5 is a schematic structure diagram of a driving circuit communication device of a TFT-LCD according to another embodiment of the present disclosure;

FIG. 6 is a schematic structure diagram of a driving circuit communication device of a TFT-LCD according to another embodiment of the present disclosure;

FIG. 7 is a schematic diagram of a driving circuit system of a TFT-LCD according to an embodiment of the present disclosure;

FIG. 8 is a schematic diagram of a driving circuit system of a TFT-LCD according to another embodiment of the present disclosure; and

FIG. 9 is a schematic diagram of a driving circuit system of a TFT-LCD according to another embodiment of the present disclosure.

### DETAILED DESCRIPTION OF THE PREFERRED EMBODIMENT

The following content combines with the drawings and the embodiment for describing the present invention in detail. It is obvious that the following embodiments are only some embodiments of the present invention. For the person of ordinary skill in the art without creative effort, the other embodiments obtained thereby are still covered by the present invention.

The embodiments of the present disclosure provides a driving circuit communication method, a communication device and system of a TFT-LCD, which is capable of increasing the utilization rate of the external mounted storage device so as to decrease a packaging area for the device and decrease the cost of the device at the same time.

The following content will illustrate respectively.

It should be noted that relational terms in the specification, claims and the above figures, the terms “comprise,” include,” or any other variation thereof, are intended to cover a non-exclusive inclusion, such that a series of elements including the process, method, article or device that includes not only those elements but also other elements not expressly listed or further comprising such process, method, article or device inherent elements or selectively comprising other inherent steps or units for these process, method, article or device.

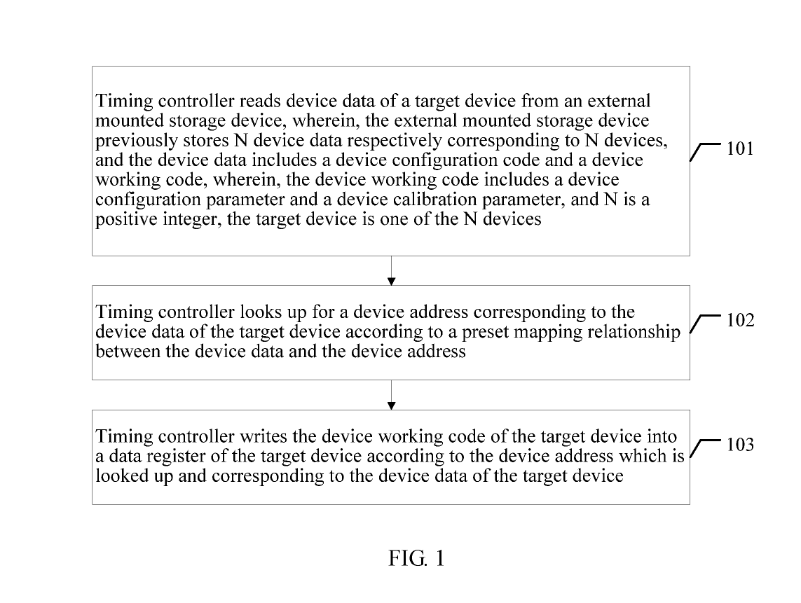

With reference to FIG. 1, and FIG. 1 is a flowchart of a driving circuit communication method of a TFT-LCD according to an embodiment of the present disclosure. As shown in FIG. 1, the driving circuit communication method of the TFT-LCD includes following steps:

101, a timing controller reads device data of a target device from an external mounted storage device, wherein, the external mounted storage device previously stores N device data respectively corresponding to N devices. The device data includes a device configuration code and a device working code. The device working code includes a device configuration parameter and a device calibration parameter, and N is a positive integer. The target device is one of the above N devices.

In the present embodiment, the external mounted storage device can be an EEPROM (Electrically Erasable Programmable Read-Only Memory), and also can be a FLASH. The present embodiment is not limited.

The above target device can include one of following target devices: a programmable gamma correction buffer circuit chip (P-Gamma), a power management chip (PWM IC) or other related devices. The present embodiment is not limited.

The above device configuration code can include some necessary configuration parameters when a timing controller visits the device. For example, basic information of a device address or a device data length, and so on. After the timing controller allocates the above device configuration code, the timing controller is possible to build a communication connection with the target device for writing the device working code into the target device.

It can be understood that the realization method that the timing controller reads the device data of the target device from the external mounted storage device is various.

For example, when an external mounted EEPROM is provided, the timing controller reads the device data of the target device from the external mounted EEPROM through Inter Integrated Circuit (IIC).

For example, when an external mounted FLASH is provided, the timing controller reads the device data of the target device from the external mounted FLASH through Serial Peripheral Interface (SPI).

102, the timing controller looks up for a device address corresponding to the device data of the target device according to a preset mapping relationship between the device data and the device address.

In the present embodiment, the external mounted storage can store an index address list of a mapping relationship among an index of the device data, an index of the device address and the device data and the device address. The timing controller can obtain the device address corresponding to the only one index of the device data of the target device through looking up for the index address list.

For example, the external mounted storage can store an index address list of a mapping relationship among an index of the device data corresponding to N devices, an index of N device addresses and device data and the device data. That is, the index address list includes a mapping relationship between the indexes of N device data and the N device addresses. The timing controller can obtain the device address corresponding to the only one index of the device data of the target device through looking up for the index address list.

103, the timing controller writes the device working code of the target device into a data register of the target device according to the device address which is looked up and corresponding to the device data of the target device.

In the present embodiment, it can be understood that the realization method that the timing controller writes the device working code which is read into a data register of the target device is: when an external mounted EEPROM/FLASH is provided, the timing controller writes the device working code of the target device into the data register of the target device through Inter Integrated Circuit (IIC).

In the present embodiment, the specific realization method that the timing controller writes the device working code which is already read of the target device into the data register of the target device is: the timing controller determines that if the device working code of the target device is effective. If the timing controller determines that the device working code of the target device is effective, the timing controller writes the device code of the target device into the data register of the target device.

Specifically, a specific realization method that the timing controller determines that if the device working code of the target device is effective is: the timing controller detects that if a device calibration parameter of the target device read by the timing controller is matched with a device calibration parameter calculated by the timing controller in real-time. If the device calibration parameter of the target device read by the timing controller is matched with the device calibration parameter calculated by the timing controller in real-time, the timing controller determines that the device working code is effective; if the device calibration parameter of the target device read by the timing controller is not matched with the device calibration parameter calculated by the timing controller in real-time, the timing controller determines that the device working code is ineffective.

In the present embodiment, the timing controller reads the device data of the target device from the external mounted storage device; looking up for the device address corresponding to the device data of the target device according to a preset mapping relationship between the device data and the device address; writing the device working code of the target device which is read into the data register of the target device according to the device address corresponding to the device data of the target device. In the present embodiment, in the external mounted storage device, a remaining space except a space for storing a code of a timing controller is used for storing the device data of the target device so that the target device does not require providing with a fixed storage device for storing the device data. Accordingly, the utilization rate of the external mounted storage device is increased so as to decrease a packaging area for the device and decrease the cost of the device at the same time.

As an optional embodiment, in a solution shown in FIG. 1, after the timing controller executes the step 101, a following step can be executed:

The timing controller stores the device data of the target device in a random access memory (RAM) inside the timing controller within a preset time period.

In the present embodiment, the preset time period is from a t1 moment to a t2 moment. The t1 moment is a storage start moment, that is a moment that the timing controller finish reading the device data of the target device from the external mounted storage device; the t2 moment is a storage end moment, that is, a moment that the timing controller writes the device working code of the target device which is read into the data register of the target device according to the device address which is looked up and corresponding to the device data of the target device.

As an optional embodiment, in the solution shown in FIG. 1, after the timing controller executes the step 103, a following step can be executed:

The timing controller monitors if a working status of the target device is normal; if the working status of the target device monitored by the timing controller is abnormal, executing the step of the timing controller writes the device working code of the target device into a data register of the target device according to the device address which is looked up and corresponding to the device data of the target device.

Specifically, the specific realization method that the timing controller monitors if a working status of the target device is normal is:

The timing controller builds a communication connection between a status register of the target device and the timing controller;

The timing controller reads a working status information of the target device from the status register of the target device through the communication connection;

In the case that the timing controller determines that the working status information of the target device is correct, determining that the working status of the target device is normal;

In the case that the timing controller determines that the working status information of the target device is wrong, determining that the working status of the target device is abnormal.

As an optional embodiment, in the solution shown in FIG. 1, after the timing controller executes the step 103, a following step can be executed:

The timing controller monitors if a working status of the target device is normal; if the working status of the target device is monitored as to be abnormal, execute the step of the timing controller writes the device working code of the target device into a data register of the target device according to the device address which is looked up and corresponding to the device data of the target device.

Specifically, the specific realization method that the timing controller monitors if a working status of the target device is normal is:

The timing controller builds a communication connection between a status register of the target device and the timing controller;

The timing controller reads a working status information of the target device from the status register of the target through the communication connection;

In the case that the timing controller determines that the working status information of the target device is correct, determining that the working status of the target device is normal;

In the case that the timing controller determines that the working status information of the target device is wrong, determining that the working status of the target device is abnormal;

As an optional embodiment, in the solution shown in FIG. 1, when reading device data of multiple target devices from the external mounted storage device, after the timing controller executes the step 103, a following step can be executed:

The timing controller monitors if a working status of a current target device is normal;

if the working status of the current target device monitored by the timing controller is abnormal, executing the step of the timing controller writes the device working code which is read of the target device into a data register of the current target device corresponding to the device address which is looked up of the current target device, and the timing controller also executes a step of monitoring if a working status of a current target device is normal.

If the timing controller monitors that the working status of the current target device is normal, using a next target device as the current target device, the timing controller executes a step of monitoring if a working status of a current target device is normal; until the timing controller finish monitoring if the working status of all target devices are normal.

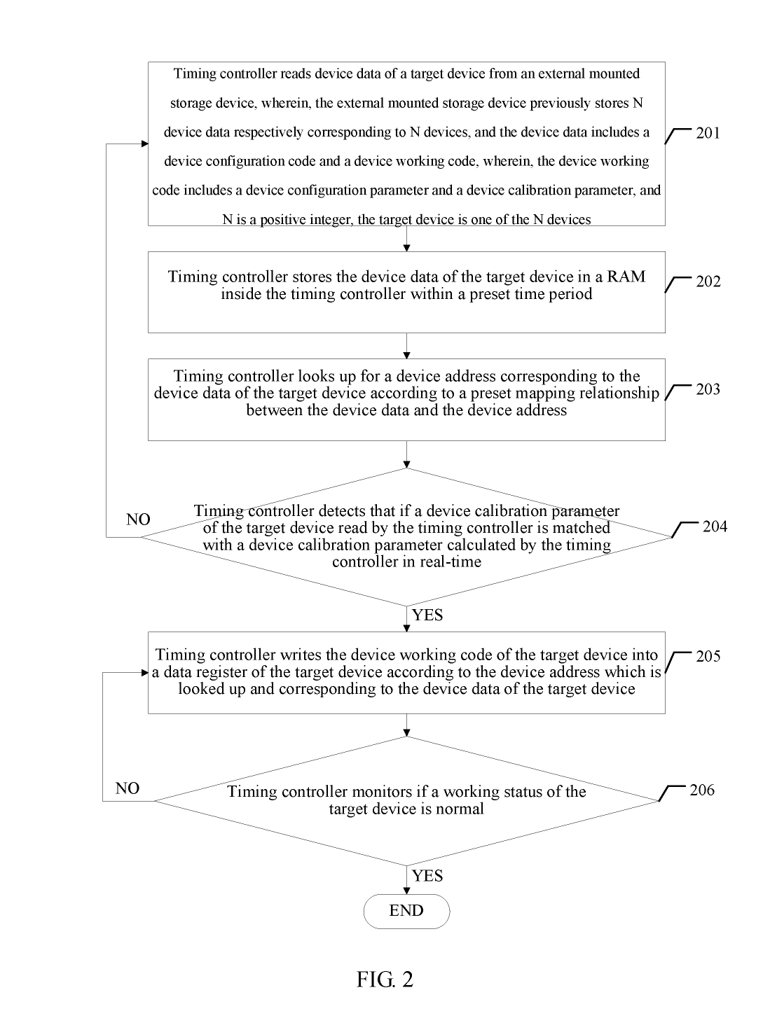

With reference to FIG. 2, and FIG. 2 is a flowchart of a driving circuit communication method of a TFT-LCD according to an embodiment of the present disclosure. As shown in FIG. 2, the driving circuit communication method of the TFT-LCD includes following steps:

201, a timing controller reads device data of a target device from an external mounted storage device, wherein, the external mounted storage device previously stores N device data respectively corresponding to N devices. The device data includes a device configuration code and a device working code. The device working code includes a device configuration parameter and a device calibration parameter, and N is a positive integer. The target device is one of the above N devices.

In the present embodiment, the external mounted storage device can be an EEPROM (Electrically Erasable Programmable Read-Only Memory), and also can be a FLASH. The present embodiment is not limited.

The above target device can include one of following target devices: a programmable gamma correction buffer circuit chip (P-Gamma), a power management chip (PWM IC) or other related devices. The present embodiment is not limited.

The above device configuration code can include some necessary configuration parameters when a timing controller visits the device. For example, basic information of a device address or a device data length, and so on. After the timing controller allocates the above device configuration code, the timing controller is possible to build a communication connection with the target device for writing the device working code into the target device.

It can be understood that the realization method that the timing controller reads the device data of the target device from the external mounted storage device is various.

For example, when an external mounted EEPROM is provided, the timing controller reads the device data of the target device from the external mounted EEPROM through Inter Integrated Circuit (IIC).

For example, when an external mounted FLASH is provided, the timing controller reads the device data of the target device from the external mounted FLASH through Serial Peripheral Interface (SPI).

202, the timing controller stores the device data of the target device in a random access memory (RAM) inside the timing controller within a preset time period.

In the present embodiment, the preset time period is from a t1 moment to a t2 moment. The t1 moment is a storage start moment, that is a moment that the timing controller finish reading the device data of the target device from the external mounted storage device; the t2 moment is a storage end moment, that is, a moment that the timing controller writes the device working code of the target device which is read into the data register of the target device according to the device address which is looked up and corresponding to the device data of the target device.

203, the timing controller looks up for a device address corresponding to the device data of the target device according to a preset mapping relationship between the device data and the device address.

In the present embodiment, the external mounted storage can store an index address list of a mapping relationship among an index of the device data, an index of the device address and the device data and the device address. The timing controller can obtain the device address corresponding to the only one index of the device data of the target device through looking up for the index address list.

For example, the external mounted storage can store an index address list of a mapping relationship among an index of the device data corresponding to N devices, an index of N device addresses and device data and the device data. That is, the index address list includes a mapping relationship between the indexes of N device data and the N device addresses. The timing controller can obtain the device address corresponding to the only one index of the device data of the target device through looking up for the index address list.

204, the timing controller detects that if a device calibration parameter of the target device read by the timing controller is matched with a device calibration parameter calculated by the timing controller in real-time. If yes, the device working code is effective, and continuing to execute a step 205; if no, the device working code is ineffective, and returning to execute the step 201.

205, the timing controller writes the device working code of the target device into a data register of the target device according to the device address which is looked up and corresponding to the device data of the target device.

In the present embodiment, it can be understood that the realization method that the timing controller writes the device working code which is read into a data register of the target device is: when an external mounted EEPROM/FLASH is provided, the timing controller writes the device working code of the target device into the data register of the target device through Inter Integrated Circuit (IIC).

206, the timing controller monitors if a working status of the target device is normal; if the working status of the target device monitored by the timing controller is abnormal, the timing controller executes the step of writing the device working code of the target device into a data register of the target device according to the device address which is looked up and corresponding to the device data of the target device.

Specifically, the specific realization method that the timing controller monitors if a working status of the target device is normal is:

The timing controller builds a communication connection between a status register of the target device and the timing controller;

The timing controller reads a working status information of the target device from the status register of the target device through the communication connection;

In the case that the timing controller determines that the working status information of the target device is correct, determining that the working status of the target device is normal;

In the case that the timing controller determines that the working status information of the target device is wrong, determining that the working status of the target device is abnormal.

In the present embodiment, the timing controller reads the device data of the target device from the external mounted storage device; the timing controller stores the device data of the target device in a random access memory (RAM) inside the timing controller within a preset time period; looking up for the device address corresponding to the device data of the target device according to a preset mapping relationship between the device data and the device address; the timing controller detects that if a device calibration parameter of the target device read by the timing controller is matched with a device calibration parameter calculated by the timing controller in real-time. If yes, the device working code is effective, and continuing to execute a step of the timing controller writes the device working code of the target device into a data register of the target device according to the device address which is looked up and corresponding to the device data of the target device; if no, the device working code is ineffective, and returning to execute the step of a timing controller reads device data of a target device from an external mounted storage device; the timing controller monitors if a working status of the target device is normal; if the working status of the target device monitored by the timing controller is abnormal, the timing controller executes the step of writing the device working code of the target device into a data register of the target device according to the device address which is looked up and corresponding to the device data of the target device. In the present embodiment, in the external mounted storage device, a remaining space except a space for storing a code of a timing controller is used for storing the device data of the target device so that the target device does not require providing with a fixed storage device for storing the device data. Accordingly, the utilization rate of the external mounted storage device is increased so as to decrease a packaging area for the device and decrease the cost of the device at the same time.

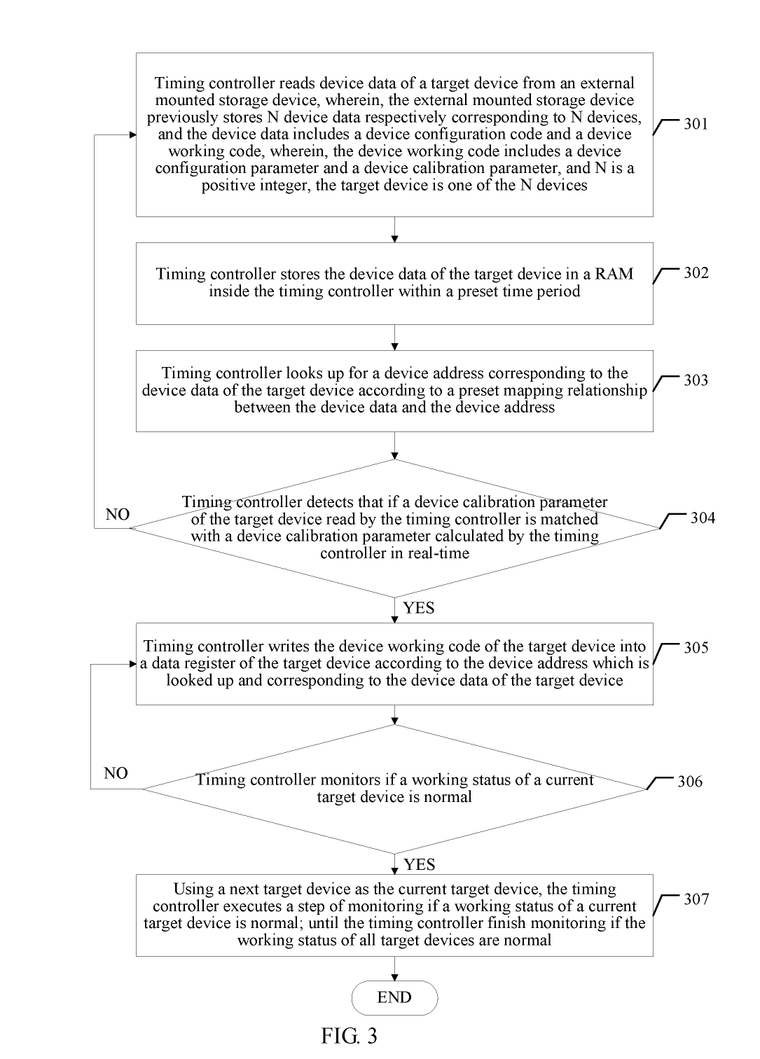

With reference to FIG. 3, and FIG. 3 is a flowchart of a driving circuit communication method of a TFT-LCD according to an embodiment of the present disclosure. As shown in FIG. 3, the driving circuit communication method of the TFT-LCD includes following steps:

301, a timing controller reads device data of a target device from an external mounted storage device, wherein, the external mounted storage device previously stores N device data respectively corresponding to N devices. The device data includes a device configuration code and a device working code. The device working code includes a device configuration parameter and a device calibration parameter, and N is a positive integer. The target device is one of the above N devices.

In the present embodiment, the external mounted storage device can be an EEPROM (Electrically Erasable Programmable Read-Only Memory), and also can be a FLASH. The present embodiment is not limited.

The above target device can include one of following target devices: a programmable gamma correction buffer circuit chip (P-Gamma), a power management chip (PWM IC) or other related devices. The present embodiment is not limited.

The above device configuration code can include some necessary configuration parameters when a timing controller visits the device. For example, basic information of a device address or a device data length, and so on. After the timing controller allocates the above device configuration code, the timing controller is possible to build a communication connection with the target device for writing the device working code into the target device.

It can be understood that the realization method that the timing controller reads the device data of the target device from the external mounted storage device is various.

For example, when an external mounted EEPROM is provided, the timing controller reads the device data of the target device from the external mounted EEPROM through Inter Integrated Circuit (IIC).

For example, when an external mounted FLASH is provided, the timing controller reads the device data of the target device from the external mounted FLASH through Serial Peripheral Interface (SPI).

302, the timing controller stores the device data of the target device in a random access memory (RAM) inside the timing controller within a preset time period.

In the present embodiment, the preset time period is from a t1 moment to a t2 moment. The t1 moment is a storage start moment, that is a moment that the timing controller finish reading the device data of the target device from the external mounted storage device; the t2 moment is a storage end moment, that is, a moment that the timing controller writes the device working code of the target device which is read into the data register of the target device according to the device address which is looked up and corresponding to the device data of the target device.

303, the timing controller looks up for a device address corresponding to the device data of the target device according to a preset mapping relationship between the device data and the device address.

In the present embodiment, the external mounted storage can store an index address list of a mapping relationship among an index of the device data, an index of the device address and the device data and the device address. The timing controller can obtain the device address corresponding to the only one index of the device data of the target device through looking up for the index address list.

For example, the external mounted storage can store an index address list of a mapping relationship among an index of the device data corresponding to N devices, an index of N device addresses and device data and the device data. That is, the index address list includes a mapping relationship between the indexes of N device data and the N device addresses. The timing controller can obtain the device address corresponding to the only one index of the device data of the target device through looking up for the index address list.

304, the timing controller detects that if a device calibration parameter of the target device read by the timing controller is matched with a device calibration parameter calculated by the timing controller in real-time. If yes, the device working code is effective, and continuing to execute a step 305; if no, the device working code is ineffective, and returning to execute the step 301.

305, the timing controller writes the device working code of the target device into a data register of the target device according to the device address which is looked up and corresponding to the device data of the target device.

In the present embodiment, it can be understood that the realization method that the timing controller writes the device working code which is read into a data register of the target device is: when an external mounted EEPROM/FLASH is provided, the timing controller writes the device working code of the target device into the data register of the target device through Inter Integrated Circuit (IIC).

306, the timing controller monitors if a working status of a current target device is normal: if the working status of the current target device monitored by the timing controller is abnormal, executing the step of the timing controller writes the device working code which is read of the target device into a data register of the current target device corresponding to the device address which is looked up of the current target device, and the timing controller also executes a step of monitoring if a working status of a current target device is normal.

If the timing controller monitors that the working status of the current target device is normal, continuing to execute a step 307.

307, using a next target device as the current target device, the timing controller executes a step of monitoring if a working status of a current target device is normal; until the timing controller finish monitoring if the working status of all target devices are normal.

In the present embodiment, the timing controller reads the device data of the target device from the external mounted storage device; the timing controller stores the device data of the target device in a random access memory (RAM) inside the timing controller within a preset time period; looking up for the device address corresponding to the device data of the target device according to a preset mapping relationship between the device data and the device address; the timing controller detects that if a device calibration parameter of the target device read by the timing controller is matched with a device calibration parameter calculated by the timing controller in real-time. If yes, the device working code is effective, and continuing to execute a step of the timing controller writes the device working code of the target device into a data register of the target device according to the device address which is looked up and corresponding to the device data of the target device; if no, the device working code is ineffective, and returning to execute the step of a timing controller reads device data of a target device from an external mounted storage device; the timing controller monitors if a working status of a current target device is normal: if the working status of the current target device monitored by the timing controller is abnormal, executing the step of the timing controller writes the device working code which is read of the target device into a data register of the current target device corresponding to the device address which is looked up of the current target device, and the timing controller also executes a step of monitoring if a working status of a current target device is normal. If the timing controller monitors that the working status of the current target device is normal, using a next target device as the current target device, the timing controller executes a step of monitoring if a working status of a current target device is normal; until the timing controller finish monitoring if the working status of all target devices are normal. In the present embodiment, in the external mounted storage device, a remaining space except a space for storing a code of a timing controller is used for storing the device data of the target device so that the target device does not require providing with a fixed storage device for storing the device data. Accordingly, the utilization rate of the external mounted storage device is increased so as to decrease a packaging area for the device and decrease the cost of the device at the same time.

The following illustrates the device embodiment of the present disclosure; the device embodiment is used for executing the method embodiment 1 to 3 of the present disclosure. For illustrating conveniently, only related parts of the present embodiment are shown, the specific technology detail which is not disclosed can refer to embodiment 1 to embodiment 3.

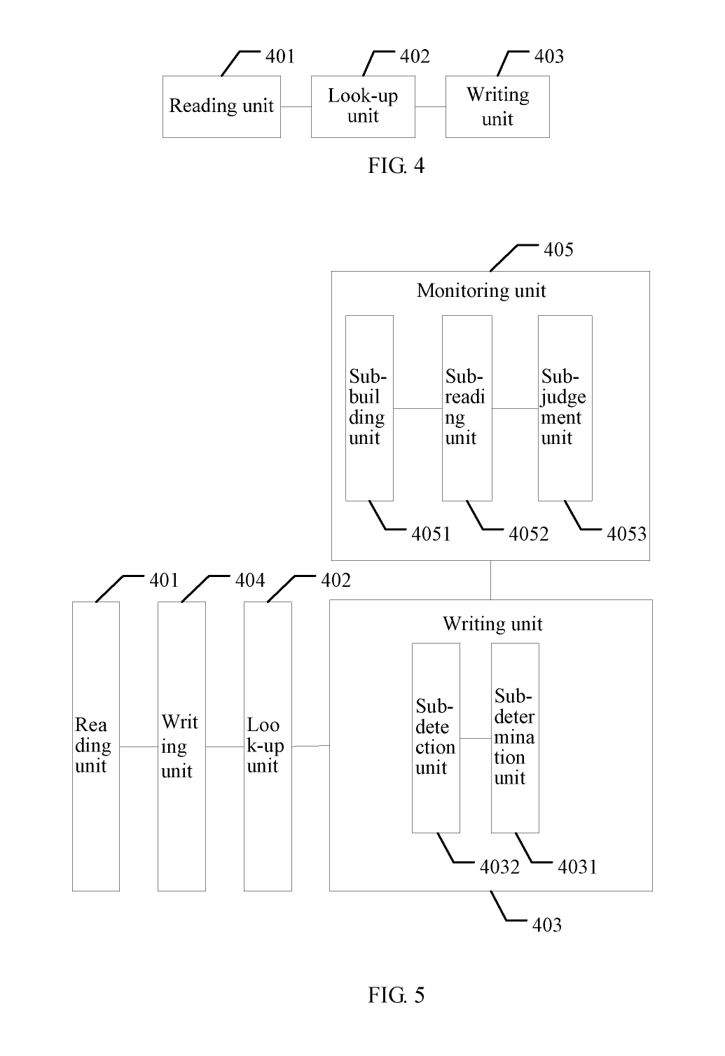

With reference to FIG. 4, and FIG. 4 is a schematic structure diagram of a driving circuit communication device of a TFT-LCD. As shown in FIG. 4, the device includes:

A reading unit 401, used for reading device data of a target device from an external mounted storage device, wherein, the external mounted storage device previously stores N device data respectively corresponding to N devices. The device data includes a device configuration code and a device working code. The device working code includes a device configuration parameter and a device calibration parameter, and N is a positive integer. The target device is one of the above N devices;

A look-up unit 402, used for looking up for a device address corresponding to the device data of the target device according to a preset mapping relationship between the device data and the device address;

A writing unit 403, used for writing the device working code of the target device read by the reading unit 401 into a data register of the target device according to the device address which is looked up by the look-up unit 402 and corresponding to the device data of the target device.

In the present embodiment, the reading unit 401 reads the device data of the target device from the external mounted storage device; the look-up unit 403 looks up for the device address corresponding to the device data of the target device according to a preset mapping relationship between the device data and the device address; the writing unit 403 writes the device working code of the target device which is read by the reading unit 401 into the data register of the target device according to the device address looked up by the look-up unit 402 and corresponding to the device data of the target device. In the present embodiment, in the external mounted storage device, a remaining space except a space for storing a code of a timing controller is used for storing the device data of the target device so that the target device does not require providing with a fixed storage device for storing the device data. Accordingly, the utilization rate of the external mounted storage device is increased so as to decrease a packaging area for the device and decrease the cost of the device at the same time.

With reference to FIG. 5, and FIG. 5 is a schematic structure diagram of a driving circuit communication device of a TFT-LCD. The driving circuit communication device of the TFT-LCD is optimized by the driving circuit communication device of the TFT-LCD shown in FIG. 4 used for when the reading unit 401 reads device data of multiple target devices from the external mounted storage device. The driving circuit communication device of the TFT-LCD shown in FIG. 5 further includes:

A storage unit 404 is used for storing the device data of the target device in a random access memory (RAM) inside the timing controller within a preset time period after the reading unit 401 read the device data of the target device from the external mounted storage device.

In the present embodiment, the writing unit 403 further includes:

A sub-determination unit 4031, used for determining that if the device working code of the target device is effective.

The sub-determination unit 4031 is specifically used for when determining that the device working code of the target device is effective, trigger the writing unit 403 to executes an action of writing the device working code of the target device read by the reading unit 401 into a data register of the target device according to the device address which is looked up by the look-up unit 402 and corresponding to the device data of the target device.

In the present embodiment, the writing unit 403 further includes:

A sub-detection unit 4032, used for detecting that if a device calibration parameter of the target device read by the timing controller is matched with a device calibration parameter calculated by the timing controller in real-time.

The sub-determination unit 4031 is specifically used for if the sub-detection unit 4032 detects that the device calibration parameter of the target device read by the timing controller is matched with the device calibration parameter calculated by the timing controller in real-time, the sub-determination unit 4031 determines that the device working code is effective; if the sub-detection unit 4032 detects that the device calibration parameter of the target device read by the timing controller is not matched with the device calibration parameter calculated by the timing controller in real-time, the sub-determination unit 4031 determines that the device working code is ineffective.

In the present embodiment, the driving circuit communication device of the TFT-LCD further includes:

A monitoring unit 405, used for monitoring if a working status of a current target device is normal, after the writing unit 403 writes the device working code of the target device which is read by the reading unit 401 into the data register of the target device according to the device address looked up by the look-up unit 402 and corresponding to the device data of the target device;

Wherein, the monitoring unit 405 is specifically used for:

if the working status of the current target device monitored by the monitoring unit 405 is abnormal, trigger the writing unit 403 to executes an action of writing the device working code of the target device read by the reading unit 401 into a data register of the target device according to the device address which is looked up by the look-up unit 402 and corresponding to the device data of the target device, and the monitoring unit 405 also executes a step of monitoring if a working status of a current target device is normal;

if the working status of the current target device monitored by the monitoring unit 405 is normal, using a next target device as the current target device, the monitoring unit 405 executes a step of monitoring if a working status of a current target device is normal; until the finish monitoring if the working status of all target devices are normal.

In the present embodiment, the monitoring unit 405 includes:

A sub-building unit 4051, used for building a communication connection between a status register of the target device and the sub-building unit;

A sub-reading unit 4052, used for reading a working status information of the target device from the status register of the target device through the communication connection;

A sub-judgement unit 4053, used for in the case that determining that the working status information of the target device is correct, determining that the working status of the target device is normal; in the case that determining that the working status information of the target device is wrong, determining that the working status of the target device is abnormal.

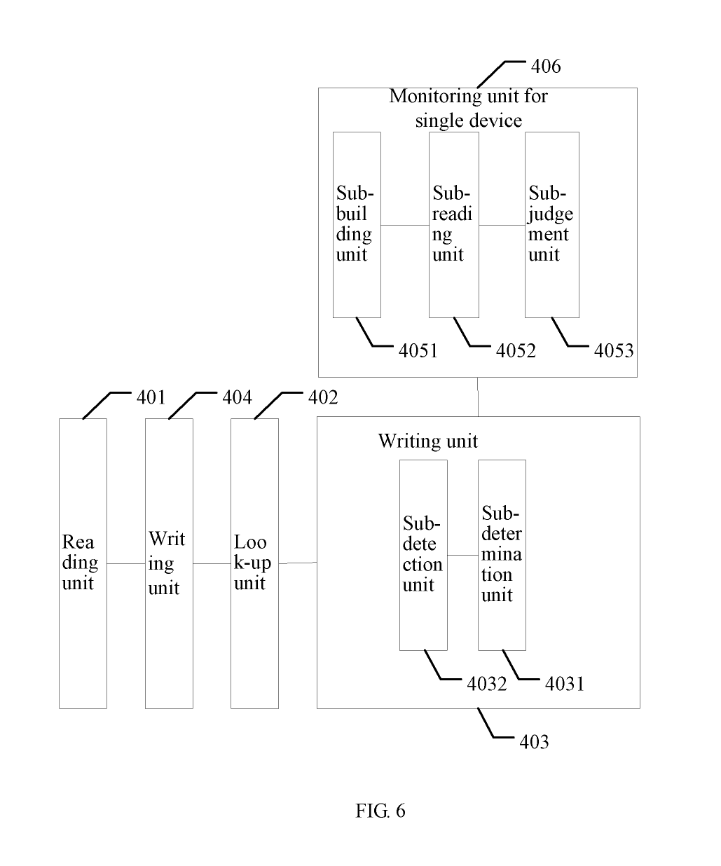

With reference to FIG. 6, and FIG. 6 is a schematic structure diagram of a driving circuit communication device of a TFT-LCD. The driving circuit communication device of the TFT-LCD is optimized by the driving circuit communication device of the TFT-LCD shown in FIG. 4 used for when the reading unit 401 reads device data of one target device from the external mounted storage device. The driving circuit communication device of the TFT-LCD shown in FIG. 6 further includes:

A storage unit 404 is used for storing the device data of the target device in a random access memory (RAM) inside the timing controller within a preset time period after the reading unit 401 read the device data of the target device from the external mounted storage device.

In the present embodiment, the writing unit 403 further includes:

A sub-determination unit 4031, used for determining that if the device working code of the target device is effective.

The sub-determination unit 4031 is specifically used for when determining that the device working code of the target device is effective, trigger the writing unit 403 to executes an action of writing the device working code of the target device read by the reading unit 401 into a data register of the target device according to the device address which is looked up by the look-up unit 402 and corresponding to the device data of the target device.

In the present embodiment, the writing unit 403 further includes:

A sub-detection unit 4032, used for detecting that if a device calibration parameter of the target device read by the timing controller is matched with a device calibration parameter calculated by the timing controller in real-time.

The sub-determination unit 4031 is specifically used for if the sub-detection unit 4032 detects that the device calibration parameter of the target device read by the timing controller is matched with the device calibration parameter calculated by the timing controller in real-time, the sub-determination unit 4031 determines that the device working code is effective; if the sub-detection unit 4032 detects that the device calibration parameter of the target device read by the timing controller is not matched with the device calibration parameter calculated by the timing controller in real-time, the sub-determination unit 4031 determines that the device working code is ineffective.

In the present embodiment, the driving circuit communication device of the TFT-LCD further includes:

A monitoring unit for a single device 406, used for monitoring if a working status of a current target device is normal, after the writing unit 403 writes the device working code of the target device which is read by the reading unit 401 into the data register of the target device according to the device address looked up by the look-up unit 402 and corresponding to the device data of the target device;

Wherein, the monitoring unit for a single device 406 is specifically used for:

if the working status of the current target device monitored by the monitoring unit for a single device 406 is abnormal, trigger the writing unit 403 to executes an action of writing the device working code of the target device read by the reading unit 401 into a data register of the target device according to the device address which is looked up by the look-up unit 402 and corresponding to the device data of the target device.

In the present embodiment, the monitoring unit for a single device 406 includes:

A sub-building unit 4051, used for building a communication connection between a status register of the target device and the sub-building unit;

A sub-reading unit 4052, used for reading a working status information of the target device from the status register of the target device through the communication connection;

A sub-judgement unit 4053, used for in the case that determining that the working status information of the target device is correct, determining that the working status of the target device is normal; in the case that determining that the working status information of the target device is wrong, determining that the working status of the target device is abnormal.

The following illustrates the system embodiment of the present disclosure; the system embodiment is used for executing the method embodiment 1 to 3 of the present disclosure. For illustrating conveniently, only related parts of the present embodiment are shown, the specific technology detail which is not disclosed can refer to embodiment 1 to embodiment 3.

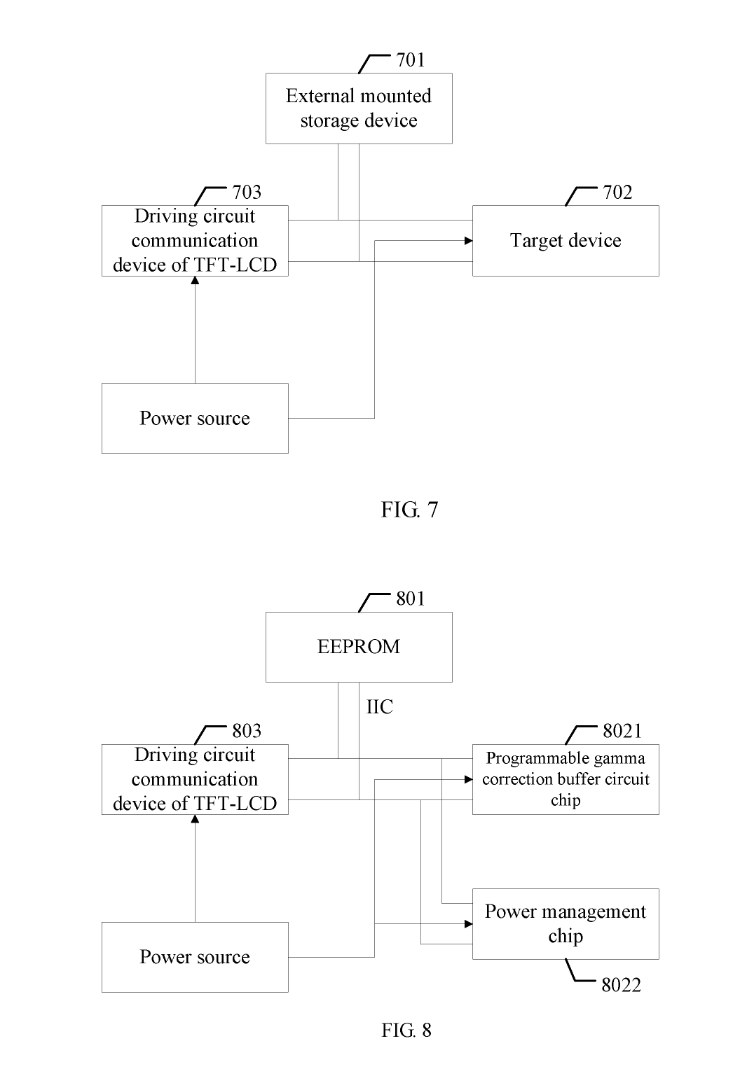

With reference to FIG. 7, and FIG. 7 is a schematic diagram of a driving circuit system of a TFT-LCD. As shown in FIG. 7, the driving circuit system of a TFT-LCD can include an external mounted storage device 701, a target device 702 and a driving circuit communication device of a TFT-LCD 703.

The external mounted storage device 701 is used for previously storing N device data of N target devices;

The target device 702 is used for carrying device data, the device data includes a device configuration code and a device working code, and the device working code includes a device configuration parameter and a device calibration parameter.

The driving circuit communication device of a TFT-LCD 703 is used for reading device data of a target device from an external mounted storage device, looking up for a device address corresponding to the device data of the target device according to a preset mapping relationship between the device data and the device address, and writing the device working code of the target device which us read into a data register of the target device according to the device address which is looked up and corresponding to the device data of the target device.

In the present embodiment, the external mounted storage device 701 previously stores N device data of N target devices; the target device 702 carries device data, the device data includes a device configuration code and a device working code, and the device working code includes a device configuration parameter and a device calibration parameter; the driving circuit communication device of a TFT-LCD 703 is used for reading the device data of the target device from the external mounted storage device; looking up for the device address corresponding to the device data of the target device according to a preset mapping relationship between the device data and the device address; writing the device working codes of the target device which is read into the data register of the target device according to the device address corresponding to the device data of the target device. In the present embodiment, in the external mounted storage device 701, a remaining space except a space for storing a code of a timing controller is used for storing the device data of the target device 702 so that the target device does not require providing with a fixed storage device for storing the device data. Accordingly, the utilization rate of the external mounted storage device 701 is increased so as to decrease a packaging area for the target device 702 and decrease the cost of the target device 702 at the same time.

With reference to FIG. 8, and FIG. 8 is a schematic diagram of a driving circuit system of a TFT-LCD. FIG. 8 mainly uses that the external mounted storage device is an EEPROM (Electrically Erasable Programmable Read-Only Memory), the target device is a programmable gamma correction buffer circuit chip (P-Gamma) and a power management chip (PWM IC) as an example. As shown in FIG. 8, driving circuit system of a TFT-LCD can include an EEPROM 801, a programmable gamma correction buffer circuit chip 8021, a power management chip 8022 and a driving circuit communication device of a TFT-LCD 803.

The EEPROM 801 is used for previously storing N device data of N target devices;

The programmable gamma correction buffer circuit chip 8021 and the power management chip 8022 respectively used for carrying device data, the device data includes a device configuration code and a device working code, and the device working code includes a device configuration parameter and a device calibration parameter.

The driving circuit communication device of a TFT-LCD 803 is used for reading device data of a target device from the external mounted EEPROM 801 through Inter Integrated Circuit (IIC), looking up for a device address corresponding to the device data of the target device according to a preset mapping relationship between the device data and the device address, and writing the device working code of the target device which us read into a data register of the target device according to the device address which is looked up and corresponding to the device data of the target device through Inter Integrated Circuit (IIC).

A power source, used for supplying power to the programmable gamma correction buffer circuit chip 8021 and the power management chip 8022 and the driving circuit communication device of a TFT-LCD 803.

In the present embodiment, the external mounted EEPROM 801 previously stores N device data of N target devices; the programmable gamma correction buffer circuit chip 8021 and the power management chip 8022 carry device data, the device data includes a device configuration code and a device working code, and the device working code includes a device configuration parameter and a device calibration parameter; the driving circuit communication device of a TFT-LCD 803 is used for reading the device data of the target device from the external mounted EEPROM 801; looking up for the device address corresponding to the device data of the target device according to a preset mapping relationship between the device data and the device address; writing the device working codes of the target device which is read into the data register of the target device according to the device address corresponding to the device data of the target device through IIC. In the present embodiment, in the external mounted EEPROM 801, a remaining space except a space for storing a code of a timing controller is used for storing the device data of the target device so that the programmable gamma correction buffer circuit chip 8021 and the power management chip 8022 do not require providing with a fixed storage device for storing the device data. Accordingly, the utilization rate of the external mounted EEPROM 801 is increased so as to decrease a packaging area for the programmable gamma correction buffer circuit chip 8021 and the power management chip 8022 and decrease the cost of the programmable gamma correction buffer circuit chip 8021 and the power management chip 8022 at the same time.

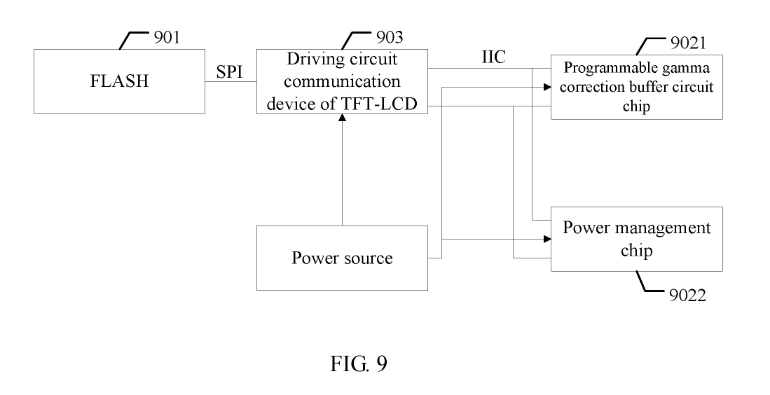

With reference to FIG. 9, and FIG. 9 is another schematic diagram of a driving circuit system of a TFT-LCD. FIG. 9 mainly uses that the external mounted storage device is a FLASH, the target device is a programmable gamma correction buffer circuit chip (P-Gamma) and a power management chip (PWM IC) as an example. As shown in FIG. 9, driving circuit system of a TFT-LCD can include an FLASH 901, a programmable gamma correction buffer circuit chip 9021, a power management chip 9022 and a driving circuit communication device of a TFT-LCD 903.

The FLASH 901 is used for previously storing N device data of N target devices;

The programmable gamma correction buffer circuit chip 9021 and the power management chip 9022 respectively used for carrying device data, the device data includes a device configuration code and a device working code, and the device working code includes a device configuration parameter and a device calibration parameter.

The driving circuit communication device of a TFT-LCD 903 is used for reading device data of a target device from the external mounted FLASH 901 through a Serial Peripheral Interface (SPI), looking up for a device address corresponding to the device data of the target device according to a preset mapping relationship between the device data and the device address, and writing the device working code of the target device which us read into a data register of the target device according to the device address which is looked up and corresponding to the device data of the target device through Inter Integrated Circuit (IIC).

A power source, used for supplying power to the programmable gamma correction buffer circuit chip 9021 and the power management chip 9022 and the driving circuit communication device of a TFT-LCD 903.

In the present embodiment, the external mounted FLASH 901 previously stores N device data of N target devices; the programmable gamma correction buffer circuit chip 9021 and the power management chip 9022 carry device data, the device data includes a device configuration code and a device working code, and the device working code includes a device configuration parameter and a device calibration parameter; the driving circuit communication device of a TFT-LCD 903 is used for reading the device data of the target device from the external mounted FLASH 901 through a SPI; looking up for the device address corresponding to the device data of the target device according to a preset mapping relationship between the device data and the device address; writing the device working codes of the target device which is read into the data register of the target device according to the device address corresponding to the device data of the target device through IIC. In the present embodiment, in the external mounted FLASH 901, a remaining space except a space for storing a code of a timing controller is used for storing the device data of the target device so that the programmable gamma correction buffer circuit chip 9021 and the power management chip 9022 do not require providing with a fixed storage device for storing the device data. Accordingly, the utilization rate of the external mounted FLASH 901 is increased so as to decrease a packaging area for the programmable gamma correction buffer circuit chip 9021 and the power management chip 9022 and decrease the cost of the programmable gamma correction buffer circuit chip 9021 and the power management chip 9022 at the same time.

Through the description of the above embodiments, person skilled in the art can clearly understand the embodiments can adopt a computer program to instruct relevant hardware to finish. The above program can store in a computer readable storage media. When the program is executing, the flowchart of the embodiments of the above method can be included. Wherein, the above storage media can be disk, CD-ROM Read-Only Memory (ROM) or Random Access Memory (RAM), etc.

The above embodiments provide a detail description of a driving circuit communication method, communication device and system of a TFT-LCD. The embodiments use a specific example for illustrating principle and embodiment way. The above embodiments are only used for helping the understanding of the method and core idea of the present disclosure. At the same time, person skilled in the art will change some portions based on the specific embodiment way or application range. In summary, the content of the present disclosure should not be understood as a limitation of the pre sent disclosure.

1. A driving circuit communication method of a TFT-LCD, comprising:
a timing controller reads device data of a target device from an external mounted storage device, wherein, the external mounted storage device previously stores N device data respectively corresponding to N devices, and the device data includes a device configuration code and a device working code, wherein, the device working code includes a device configuration parameter and a device calibration parameter, and N is a positive integer, the target device is one of the N devices;
the timing controller looks up for a device address corresponding to the device data of the target device according to a preset mapping relationship between the device data and the device address; and
the timing controller writes the device working code of the target device into a data register of the target device according to the device address which is looked up and corresponding to the device data of the target device.

2. The method according to claim 1, wherein, the step of writing the device working code of the target device into a data register of the target device includes:
the timing controller determines that if the device working code of the target device is effective, and if yes, the timing controller writes the device code of the target device into the data register of the target device.

3. The method according to claim 2, wherein, the step of the timing controller determines that if the device working code of the target device is effective includes:
the timing controller detects that if a device calibration parameter of the target device read by the timing controller is matched with a device calibration parameter calculated by the timing controller in real-time, and if yes, the device working code is effective; if no, the device working code is ineffective.

4. The method according to claim 1, wherein, after the step of the timing controller writes the device working code of the target device into a data register of the target device according to the device address which is looked up and corresponding to the device data of the target device, further includes:
the timing controller monitors if a working status of the target device is normal;
if the working status of the target device monitored by the timing controller is abnormal, executing the step of the timing controller writes the device working code of the target device into a data register of the target device according to the device address which is looked up and corresponding to the device data of the target device.

5. The method according to claim 1, wherein, when reading device data of multiple target devices from the external mounted storage device, after the step of writing the device working code of the target device into a data register of the target device according to the device address which is looked up and corresponding to the device data of the target device, further includes:
the timing controller monitors if a working status of a current target device is normal;
if the working status of the current target device monitored by the timing controller is abnormal, executing the step of the timing controller writes the device working code which is read of the target device into a data register of the current target device corresponding to the device address which is looked up of the current target device, and the timing controller also executes a step of monitoring if a working status of a current target device is normal;
if the working status of the current target device monitored by the timing controller is normal, using a next target device as a current target device, the timing controller executes a step of monitoring if a working status of the current target device is normal; until finish monitoring if the working status of all target devices are normal.

6. A driving circuit communication device of a TFT-LCD, comprising:
a reading unit for reading device data of a target device from an external mounted storage device, wherein, the external mounted storage device previously stores N device data respectively corresponding to N devices, the device data comprises a device configuration code and a device working code, the device working code comprises a device configuration parameter and a device calibration parameter, and N is a positive integer, and the target device is one of the N devices;
a look-up unit for looking up for a device address corresponding to the device data of the target device according to a preset mapping relationship between the device data and the device address; and
a writing unit for writing the device working code of the target device read by the reading unit into a data register of the target device according to the device address which is looked up by the look-up unit and corresponding to the device data of the target device.

7. The driving circuit communication device of a TFT-LCD according to claim 6, wherein, the writing unit further comprises:
a sub-determination for determining that if the device working code of the target device is effective, if yes, trigger the writing unit to write the device working code of the target device read by the reading unit into a data register of the target device.

8. The driving circuit communication device of a TFT-LCD according to claim 7, wherein, the writing unit further comprises:
a sub-detection unit for detecting that if a device calibration parameter of the target device read by the timing controller is matched with a device calibration parameter calculated by the timing controller in real-time, if yes, determining that the device working code is effective; if no, determining that the device working code is ineffective.

9. The driving circuit communication device of a TFT-LCD according to claim 6, wherein, when the reading unit reads device data of multiple target devices from the external mounted storage device, the driving circuit communication device of the TFT-LCD further includes:
a monitoring unit for monitoring if a working status of a current target device is normal;
if the working status of the current target device monitored by the monitoring unit is abnormal, trigger the writing unit to write the device working code of the target device read by the reading unit into a data register of the target device, and the monitoring unit also executes the step of monitoring if a working status of a current target device is normal; and
if the working status of the current target device monitored by the monitoring unit is normal, using a next target device as a current target device, the monitoring unit executes a step of monitoring if a working status of the current target device is normal; until the finish monitoring if the working status of all target devices are normal.

10. (canceled)

11. A driving circuit system of a TFT-LCD comprising an external mounted storage device, a target device and a driving circuit communication device of a TFT-LCD, wherein:
the external mounted storage device is used for previously storing N device data of N target devices;
the target device is used for carrying device data, the device data includes a device configuration code and a device working code, and the device working code includes a device configuration parameter and a device calibration parameter; and
the driving circuit communication device of a TFT-LCD is used for reading device data of a target device from an external mounted storage device, looking up for a device address corresponding to the device data of the target device according to a preset mapping relationship between the device data and the device address, and writing the device working code of the target device which us read into a data register of the target device according to the device address which is looked up and corresponding to the device data of the target device.

12. The driving circuit system of a TFT-LCD according to claim 10, wherein, the driving circuit communication device of a TFT-LCD comprises:
a reading unit for reading device data of a target device from an external mounted storage device, wherein, the external mounted storage device previously stores N device data respectively corresponding to N devices, the device data comprises a device configuration code and a device working code, the device working code comprises a device configuration parameter and a device calibration parameter, and N is a positive integer, and the target device is one of the N devices;
a look-up unit for looking up for a device address corresponding to the device data of the target device according to a preset mapping relationship between the device data and the device address; and
a writing unit for writing the device working code of the target device read by the reading unit into a data register of the target device according to the device address which is looked up by the look-up unit and corresponding to the device data of the target device.

13. The driving circuit system of a TFT-LCD according to claim 11, wherein, the writing unit further comprises:
a sub-determination for determining that if the device working code of the target device is effective, if yes, trigger the writing unit to write the device working code of the target device read by the reading unit into a data register of the target device.

14. The driving circuit system of a TFT-LCD according to claim 12, the writing unit further comprises:
a sub-detection unit for detecting that if a device calibration parameter of the target device read by the timing controller is matched with a device calibration parameter calculated by the timing controller in real-time, if yes, determining that the device working code is effective; if no, determining that the device working code is ineffective.

15. The driving circuit system of a TFT-LCD according to claim 11, wherein, when the reading unit reads device data of multiple target devices from the external mounted storage device, the driving circuit communication device of the TFT-LCD further includes:
a monitoring unit for monitoring if a working status of a current target device is normal;
if the working status of the current target device monitored by the monitoring unit is abnormal, trigger the writing unit to write the device working code of the target device read by the reading unit into a data register of the target device, and the monitoring unit also executes the step of monitoring if a working status of a current target device is normal; and
if the working status of the current target device monitored by the monitoring unit is normal, using a next target device as a current target device, the monitoring unit executes a step of monitoring if a working status of the current target device is normal; until the finish monitoring if the working status of all target devices are normal.
